(19) United States
(12) Patent Application Publication
(10) Pub. No.: US 2012/0240709 A1
(43) Pub. Date: Sep. 27, 2012

(54) FORCE MULTIPLYING LINKAGE

(76) Inventors: John Joseph LYDA, North Lima, OH (US); Jacques Laplante, Niles, OH (US)

(21) Appl. No.: 13/072,080

(22) Filed: Mar. 25, 2011

(51) Int. Cl. G05G 1/00

(52) U.S. Cl. 74/469

(57) ABSTRACT

A force multiplying linkage comprising a first linkage connector, a second linkage connector, a first force output member, a second force output member, the first end pivotably attached to the linkage end of the second linkage connector. The first force output member comprises a first link and a second link. A first end of the first link is attached a second end of the second force output member, a second end of the first link is pivotably attached to a first end of the second link, a second end of the second link is pivotably attached to the second linkage connector. A first stop affixed to the second link, wherein the first stop limits an angle theta when the first stop rests against the second end of the first link, and a first travel limiter interacting with the second link.

### FIELD OF INVENTION

This invention relates generally to a force multiplying over center linkage. More particularly, the invention relates to a force multiplying over center linkage that does not cause a force transmitting member to move to its most distal position on a return stroke of a force input member.

### BACKGROUND OF THE INVENTION

Force multiplying over center linkages are used for clamps and other mechanisms that require force multiplying capabilities and a locking mechanism. When over center linkages are unlocked, the linkage typically moves a force transmitting member to its most distal position on the return stroke of a force input member. For various reasons, a user may desire that an over center linkage not move the force transmitting member to its most distal position on the return stroke of the force input member.

### SUMMARY OF THE INVENTION

This invention relates to a force multiplying linkage comprising a first linkage connector having a linkage end and an acting end, a second linkage connector having a linkage end and an acting end, a first force output member, a second force output member having a first end and a second end, the first end pivotably attached to the linkage end of the second linkage connector, wherein the first force output member comprises a first link with a first end and a second end and a second link with a first end and a second end, wherein the first end of the first link is pivotably attached to the second end of the second force output member, the second end of the first link is pivotably attached to the first end of the second link, the second end of the second link is pivotably attached to the linkage end of the first linkage connector, and the first link and the second link define an angle theta, a first stop affixed to the second link, wherein the first stop limits the angle theta to a maximum between 150 and 210 degrees when the first stop rests against the second end of the first link, and a first travel limiter interacting with the second link, wherein the first travel limiter limits the pivoting travel of the second link on the second linkage connector, thereby reducing the angle theta.

This invention also relates to a linkage support locking device comprising a supporting frame, a linkage support having a backside and pivotably attached to the supporting frame, a force multiplying linkage having a first end, a second end, a first side and a second side, a first linkage connector having a linkage end connected to the force multiplying linkage and an acting end connected to the linkage support, a second linkage connector having a linkage end and an acting end, the linkage end connected to the force multiplying linkage, and a pivoting locking portion with a first leg, a second leg, and an end section, the end section pivotably attached to the supporting frame, the first leg located adjacent the first side of the force multiplying linkage, and adapted to interact with the force multiplying linkage and having a pin receiving portion to engage a locking pin, and the second leg located adjacent the second side of the multiplying linkage.

This invention further relates to a spring-retained linkage support system comprising a supporting frame, a hinged linkage support pivotably attached to the supporting frame, a force multiplying linkage with a first end and a second end, a first linkage connector having a linkage end and an acting end, wherein the linkage end is connected to the first end of the force multiplying linkage and the acting end is connected to the supporting frame, a second linkage connector having a linkage end and an acting end, wherein the linkage end is connected to the second end of the force multiplying linkage, a spring retainer, and a spring disposed between the spring retainer and the hinged linkage support for biasing the hinged linkage support against the supporting frame.

### BRIEF DESCRIPTION OF THE DRAWINGS

FIG. 1 is a perspective view of a cigarette making machine of the invention.

FIG. 2 is a side view of the tobacco conveying device of FIG. 1.

FIG. 3A is a perspective view of a portion of the cigarette making machine of FIG. 1.

FIG. 3B is an enlarged perspective view of a force multiplying linkage of the invention in the fully extended position.

FIG. 3C is a top view of the force multiplying linkage of FIG. 3B located against a center stop.

FIG. 3D is a side view of the force multiplying linkage of FIG. 3B.

FIG. 3E is a top view of the force multiplying linkage of FIG. 3B with a force input member retracting.

FIG. 3F is a top view of the force multiplying linkage of FIG. 3B in a retracted position.

FIG. 4 is a partial perspective view of the cigarette making machine of FIG. 1.

FIG. 5 is a perspective view of a pin mechanism of the invention.

FIG. 6A is a perspective view of a filling tube.

FIG. 6B is a side view of another filling tube.

FIG. 7A is a perspective view of a guide head and pin.

FIG. 7B is a side view of another embodiment of the guide head and pin.

FIG. 8A is a section view of a filling tube holding drum.

FIG. 8B is a section view of a filling tube mounted in a drum partially receiving a guide head.

FIG. 8C is a section view of a filling tube mounted in a drum fully receiving a guide head.

FIG. 8D is a section view of a filling tube mounted in a drum fully receiving a guide head showing further a blank cigarette tube being loaded onto the filling tube.

FIG. 8E is a section view of a filling tube mounted in a drum fully receiving a guide head showing further a blank cigarette tube having been fully loaded on the filling tube.

FIG. 8F is a section view of an injection pin injecting a tobacco plug into a filling tube having a blank cigarette tube loaded onto it.

FIG. 8G is a section view of a completed cigarette being ejected from a filling tube.

FIG. 9 is another partial perspective view of the cigarette making machine of FIG. 1.

FIG. 10 is another partial perspective view of the cigarette making machine of FIG. 1.

FIG. 11 is another perspective view of a pin mechanism.

FIG. 12 is another partial perspective view of a cigarette making machine of the invention.

FIG. 13A is a section view of a collapsible force input member of the invention.

FIG. 13B is a top view of a collapsible force input member connected to an arm and to a force multiplying linkage.

FIG. 14 is a section view of a pin connector of the invention.

FIG. 15A is a perspective view of a linkage support locking device of the invention.

FIG. 15B is a detailed view of a U-shaped pivoting locking portion showing a roller resting against the backside of a linkage support.

FIG. 15C is a detailed view of one embodiment of a distal end of the first leg of the U-shaped pivoting locking portion.

FIG. 15D is a detailed view of another embodiment of a distal end of the first leg of the U-shaped pivoting locking portion.

FIG. 15E is a side view of the linkage support locking device of FIG. 15A.

FIG. 15F is a top view of the linkage support locking device of FIG. 15A showing a roller offset from the backside of the linkage support.

FIG. 16A is a perspective view of a spring-retained linkage support system of the invention with the linkage in the center position.

FIG. 16B is a top view of the spring-retained linkage support system of FIG. 16A with a force input member and a linkage in the retracted position.

FIG. 16C is a top view of the spring-retained linkage support system of FIG. 16A with a force input member in the fully extended position.

FIG. 16D is a top view of the spring-retained linkage support system of FIG. 16A with a linkage in the center position on the return stroke of a force input member.

FIG. 17 is a perspective view of a reduced diameter shaft injection pin of the invention.

### DETAILED DESCRIPTION OF THE INVENTION

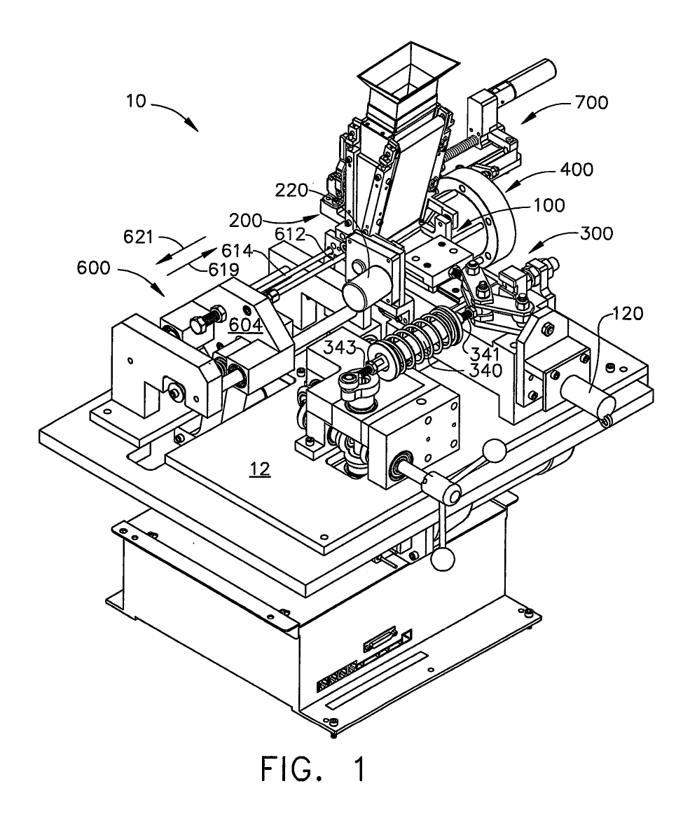

A cigarette making machine 10 is illustrated in FIG. 1. The machine 10 includes a base 12, a tobacco compaction mechanism 100, a tobacco conveying device 200, a force multiplying linkage 300, a filling tube holder 400, a pin mechanism 600, and a blank cigarette tube loader 700.

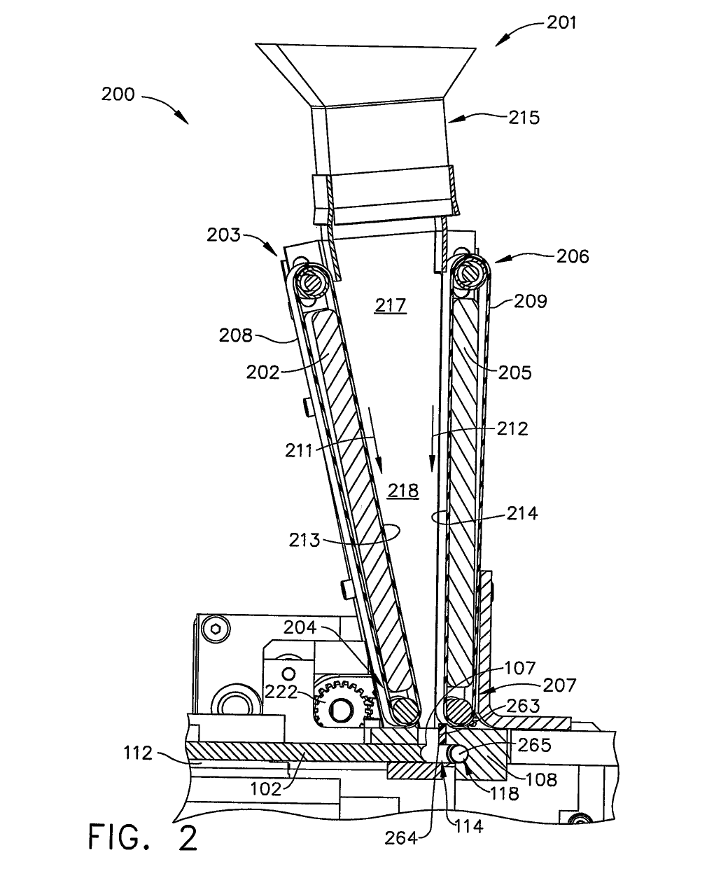

FIG. 2 illustrates the tobacco conveying device 200. The device 200 generally has an input end 201, a receiving hopper 215, a tobacco conveying zone 218, a first conveyor 202 having a top end 203 and a lower end 204, and a second conveyor 205 having a top end 206 and a lower end 207. The conveyors 202 and 205 are mounted between a first side plate 217 and a second side plate (not shown). Conveyor 202 has a conveyor belt 208, and conveyor 205 has a conveyor belt 209. The conveyor belts 208 and 209 may have styrations or fingers on them, allowing the moving belts to grip the cut tobacco. The top end 203 of the first conveyor 202 and the top end 206 of the second conveyor 205 communicate with the receiving hopper 215. Typically, the conveyors 202 and 205 converge on each other as they move in the direction of arrows 211 and 212, respectively. At least one electric motor 220 may be used to drive a gear 222 that drives the first conveyor 203 and the second conveyor 205 (see FIGS. 1, 2).

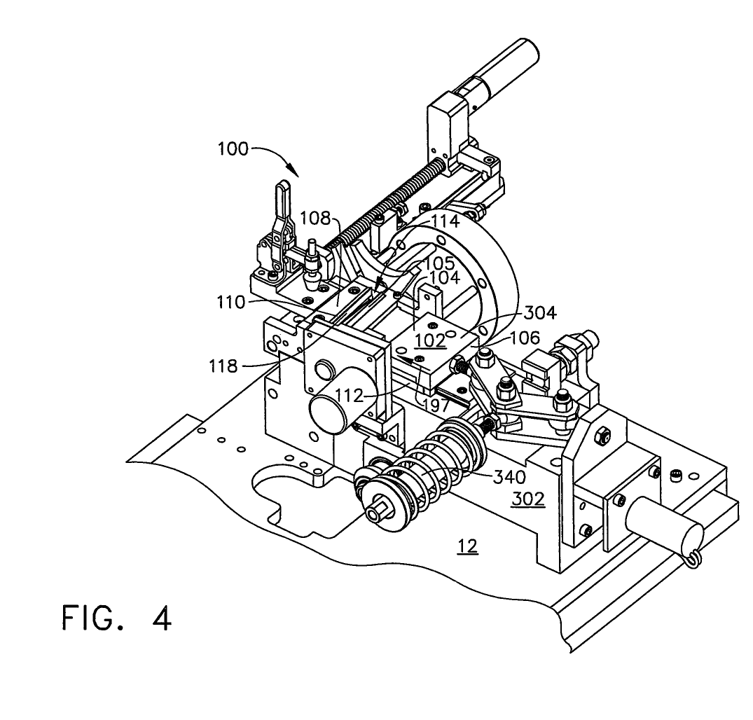

FIG. 4 shows the tobacco compaction mechanism 100 disposed on a base 12. The tobacco compaction mechanism has a force transmitting member 304, which here is a slideable compacting plate 102, with a compacting end 104 and a linkage end 106. The compacting end 104 may also have a compacting die 105. Opposite the slideable compacting plate is a second compacting plate, also referred to as a corresponding compacting plate 108, having a compacting end 110. The corresponding compacting plate may be slideable or it may be fixed. When the slideable compacting plate 102 is retracted as shown in FIG. 4, the compacting end 104 of the slideable compacting plate 102, the compacting end 110 of the corresponding compacting plate 108, and a plate 112 together form a tobacco compaction area 114. When the slideable compacting plate is moved in the direction of arrow 197 to its most distal position, the compacting end 104 of the slideable compacting plate 102 mates with the compacting end 110 of the corresponding compacting plate 108 to form a compacted tobacco cavity 118.

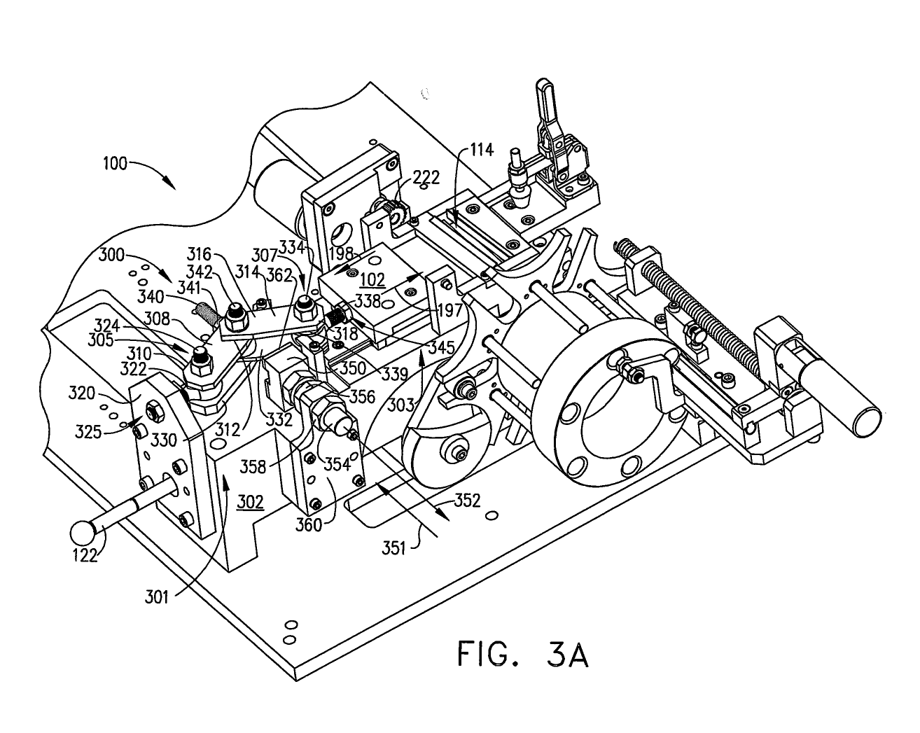

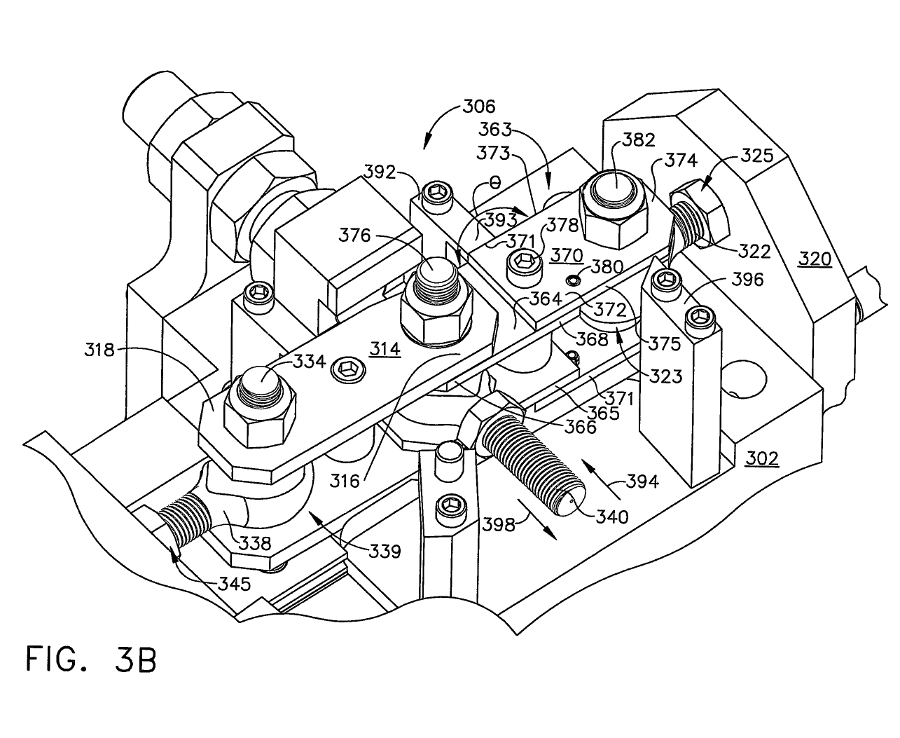

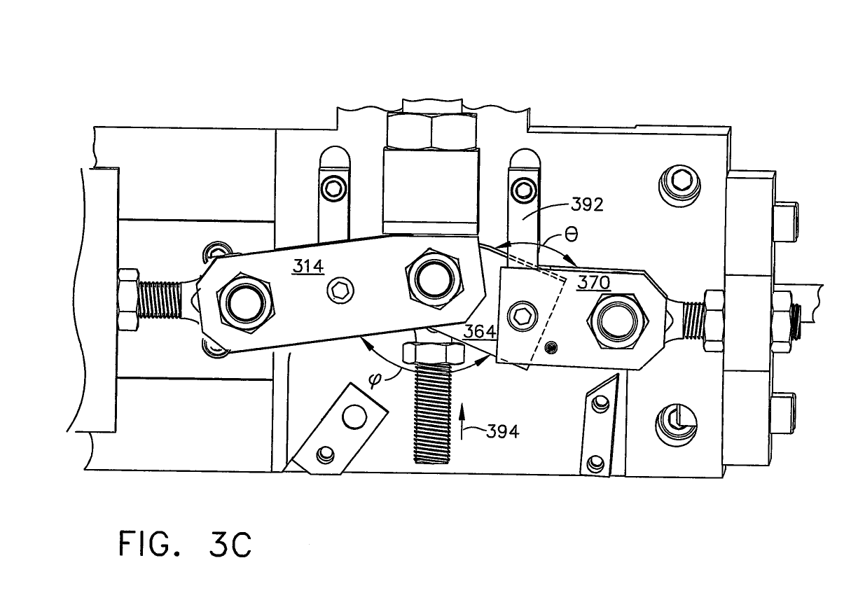

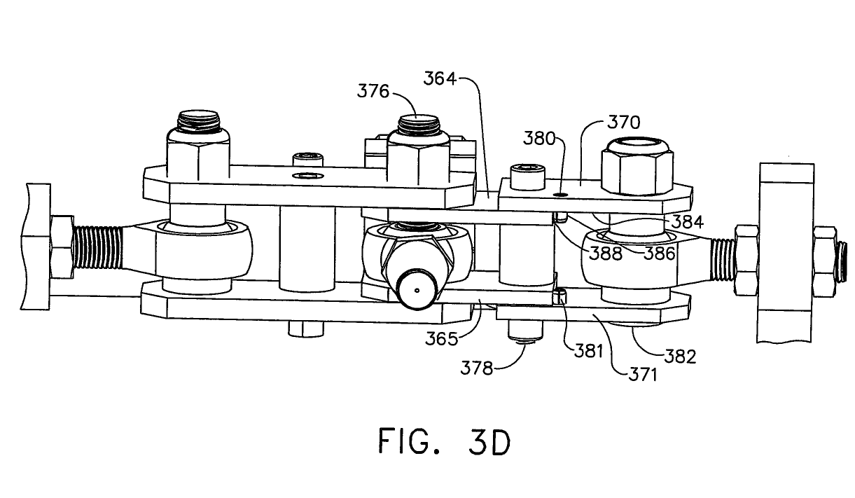

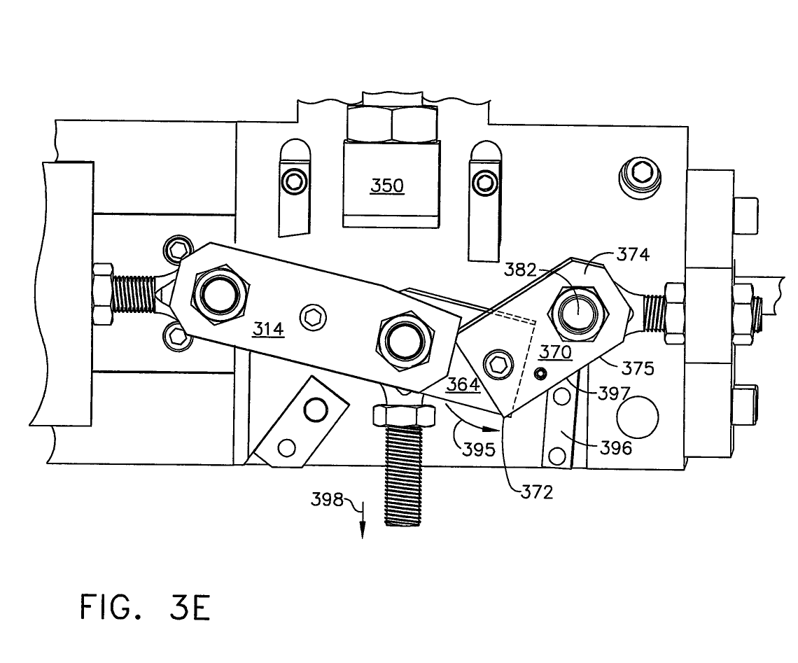

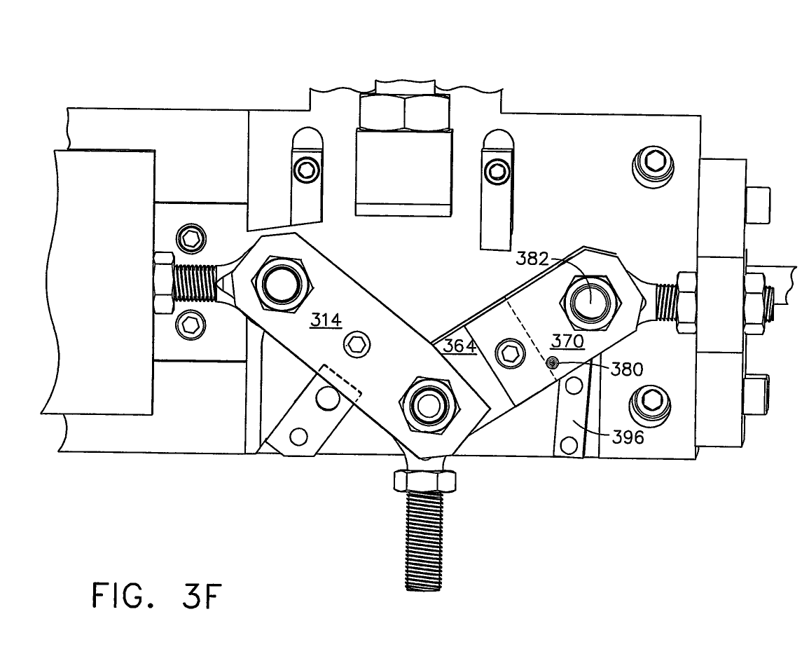

In operation, downwardly moving inner sides 213 and 214 of conveyors 202 and 205, respectively, partially compress cut tobacco and deliver it to the tobacco compaction area 114 (see FIG. 2). The conveyors 202 and 205 run for a period of time to deliver an amount of cut tobacco into the compaction area 114, and then stop. The amount of tobacco that is delivered into the compaction area 114 may be within a predetermined range, with the exact amount being established by the operator of the machine depending on individual preferences, which may include, among other things, the operator's preferred “draw” of the cigarette. Then, a force input member 340 drives the force multiplying linkage 300, which pushes the slideable compacting plate 102 toward the corresponding compacting plate 108, further compacting the tobacco in the compaction area 114 (see FIG. 3A). As the slideable compacting plate 102 moves toward the corresponding compacting plate 108, a top edge 107 of the slideable compacting plate 102 meets a cutting edge 264 of a knife 263 (see FIG. 2). FIG. 2. The cut tobacco in the compaction area 114 is then sheared from the cut tobacco in the tobacco conveying zone 218, thereby forming a tobacco plug 265 in the compacted tobacco cavity 118. Typically, the tobacco plug 265 is smaller in diameter than an inside diameter of a filling tube and a blank cigarette tube to allow for insertion of the tobacco plug into the filling tube and the blank cigarette tube. In one embodiment, a blank cigarette tube is a paper cigarette tube and filter without tobacco.

The plate 112 may also be slideable to allow it to slide away from the compaction area 114, thereby opening the bottom of the compaction area. With a slideable plate 112 open, excess tobacco located in the tobacco conveying zone 218 after a number of cigarettes have been made may be discharged through the compaction area 114 and into an excess tobacco receiving hopper (not shown) located below the compaction area 114. A rod 122 connects the plate 112 to a solenoid 120, which may be used to slide the plate (see FIGS. 1, 3A). Other mechanisms other than a solenoid, such as an electrical linear actuator, a pneumatic cylinder, or a wheel with an offset arm that drives a link, may also be used to slide the plate 112.

As shown in FIG. 3A, the tobacco compaction mechanism 100 has a force multiplying linkage 300 that pushes the slideable compacting plate 102 and is pivotably attached to a supporting frame 302 by way of a first linkage support 322 and linkage connector 322. The force multiplying linkage has a first end 305, a second end 307, a first force output member 308 that has a first end 310 and a second end 312, and a second force output member 314 that has a first end 316 and a second end 318. The first force output member 308 and the second force output member 314 may each have a corresponding force output member 330 and 332, respectively, to form a double link mechanism. The supporting frame 302 has a first end 301 and a second end 303. The first end 310 of the first force output member 308 is pivotably connected to the first end 301 of the supporting frame 302 by way of a linkage support 320. One method of connecting the first end 310 of the first force output member 308 to the supporting frame 302 and the linkage support 320 is with a first linkage connector 322 having a linkage end 323 and an acting end 325 (see FIG. 3B). Here the first linkage connector 322 is a connecting rod. A pin 324 passes through an eye in the linkage end 323 of the first linkage connector 322 and a hole in the first end 310 of the first force output member 308 to pivotably connect the first linkage connector to the first force output member. The acting end 325 of the first linkage connector 322 is connected to the linkage support 320.

The second end 318 of the second force output member 314 is pivotably connected to a slideable compacting plate 102. One method of connecting the second end 318 of the second force output member 314 to the slideable compacting plate 102 is with a second linkage connector 338 having a linkage end 339 and an acting end 345. Here the second linkage connector is a connecting rod. A pin 334 passes through an eye in the second linkage connector 338 and a hole in the second end 318 of the second force output member 314 to pivotably connect the second linkage connector to the second force output member. The acting end 345 of the second linkage connector 338 is connected to the slideable compacting plate 102.

As shown in FIGS. 1, 3A, a first end 341 of the force input member 340, the second end 312 of the first force output member 308, and the first end 316 of the second force output member 314 are pivotably connected by way of a pin 342 passing through an eye in the force input member 340, a hole in the second end of the first force output member, and a hole in the first end of the second force output member. A second end 343 of the force input member 340 is connected to an arm, described later. A center stop 350 limits the travel of the force input member in the direction shown by arrow 352. The center stop may be adjustable by way of a bolt 354 and nuts 356 and 358 that secure the center stop to a center stop vertical support 360. The stop may also include a pad 362 for cushioning the first force output member and the second force output member as they contact the center stop.

The force multiplying linkage 300 shown in FIG. 3A is in the retracted position. As the force input member 340 moves in the direction of arrow 352, the first end 310 of the first force output member 308 pivots about the pin 324, and the second end 318 of the second force output member 314 moves in the direction of arrow 197. The second end 318 of the second force output member 314 moving in the direction of arrow 197 also moves the slideable compacting plate 102 in the same direction, compacting any tobacco in the compaction area 114. When the pins 324, 342, and 334 become axially aligned, the force multiplying linkage is in its fully extended position. Thereafter, continued movement of the force input member 340 in the direction of arrow 352 will cause the pin 342 to go over center, the second end 318 of the second force output member 314 to retract slightly, and the force multiplying linkage 300 to contact the center stop 350.

On the return stroke, the force input member 340 moves in the direction of arrow 351, pulling the force multiplying linkage 300 away from the center stop 350. The second end 318 of the second force output member 314 and the slideable plate 102 will move in the direction of arrow 197 until the pin 342 comes to center and becomes axially aligned with the pins 324 and 334. Continued movement of the force input member 340 in the direction of arrow 351 will cause the second end 318 of the second force output member 314 to move toward the first end 310 of the first force output member 308 in the direction of arrow 198, thereby retracting the slideable compacting plate 102.

Typically, an injection pin (described later) passes through the compacted tobacco cavity 118 when it pushes a tobacco plug 265 out of the compacted tobacco cavity 118 and into a filing tube. If the injection pin is in the compacted tobacco cavity when the force input member 340 starts its return stroke, then the injection pin can become pinched between the slideable compacting plate 102 and the corresponding compacting plate 108. Methods available to prevent pinching the injection pin include modifying the size of the injecting pin and preventing the slideable plate from moving in the direction of arrow 197 when the force input member 340 is retracting and moving the force multiplying linkage 300 from its over-center position against the center stop 350 to the fully extended position when the pins 324, 342, and 334 are axially aligned.

FIG. 17 depicts a reduced diameter shaft injection pin 50 having an acting end 52, a connecting end 54, and a central section 56 disposed therebetween. The acting end 52 has an outside diameter 58 that is approximately the same as the tobacco plug 265 made in the compacted tobacco cavity 118. The connecting end 54 has a ball end 60 sized to fit into a socket, which is described later. The central section 56 that connects the connecting end 54 to the acting end 52 is a reduced diameter shaft that has an outside diameter 57 that is less than the outside diameter 58 of the acting end 52. The reduced diameter of the central section 56 prevents the injection pin 50 from being pinched in the compacted tobacco cavity 118 during the return stroke of the force input member.

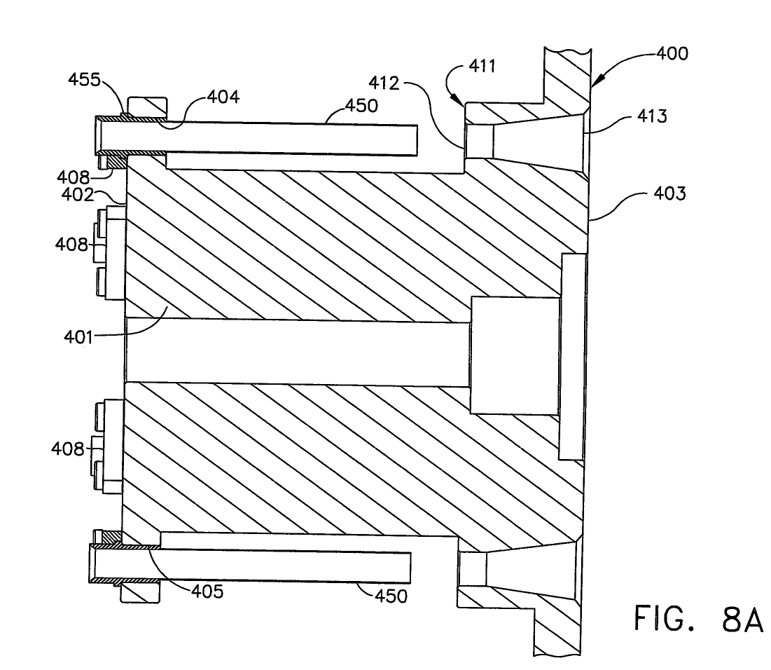

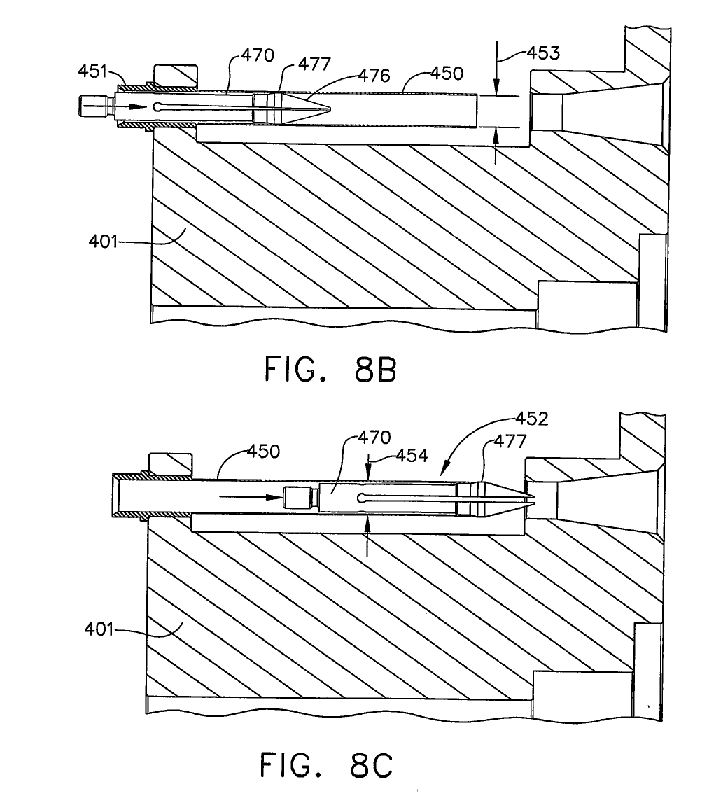

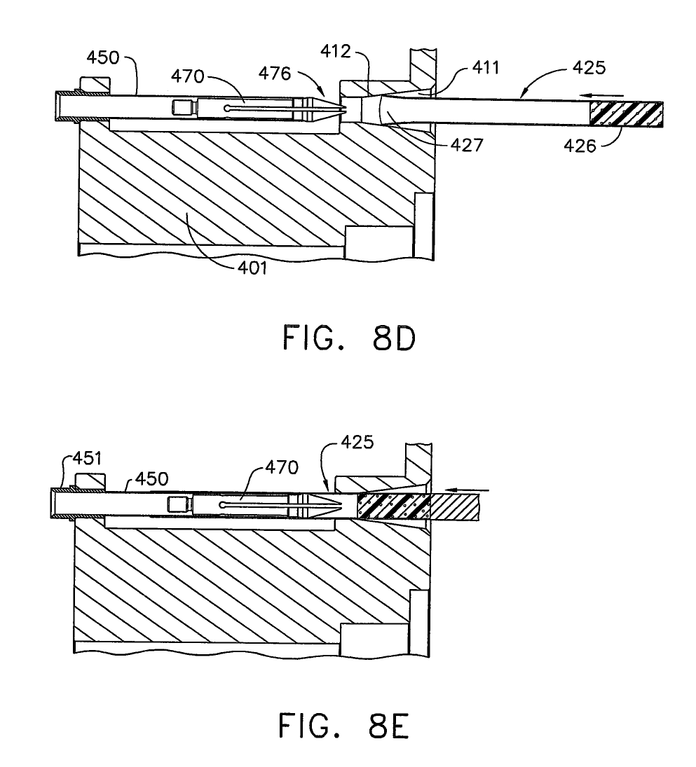

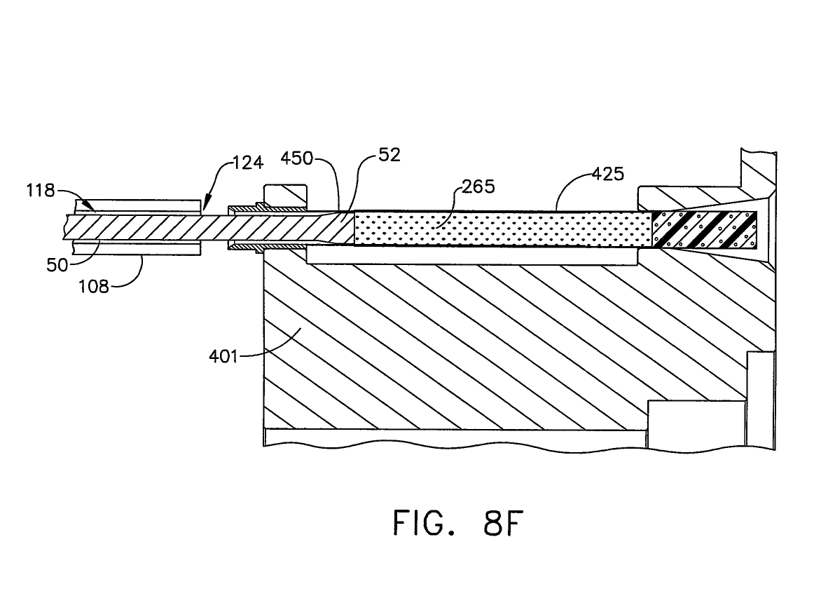

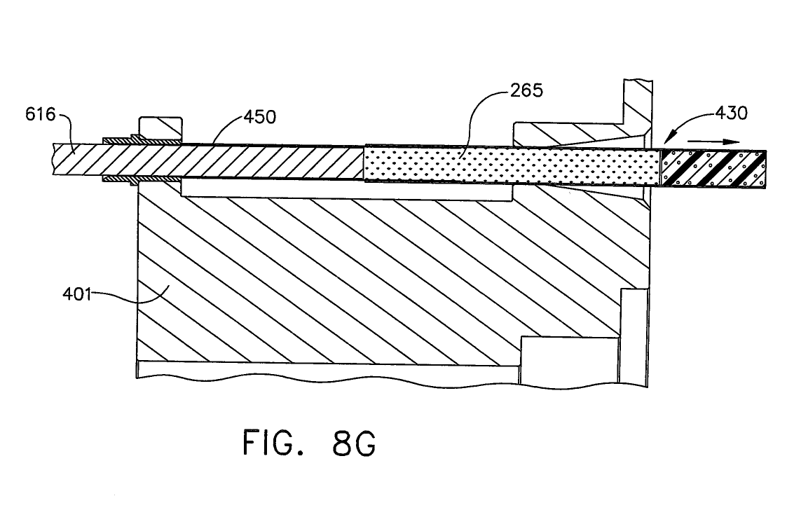

The operation of the reduced diameter shaft injection pin 50 and how it prevents pinching in the compacted tobacco cavity 118 will now be described. FIG. 8F shows the injection pin 50 loading a tobacco plug 265 into a filling tube 450 having a blank cigarette tube 425 disposed on it. The acting end 52 of the injection pin 50 has passed beyond the compacted tobacco cavity 118, formed in part by the corresponding compacting plate 108, and into the filling tube 450. After the acting end 52 has passed beyond the compacted tobacco cavity 118, the force input member 340 typically begins its return stroke, which causes the slideable compacting plate 102 to move to its most distal position as the force multiplying linkage returns to its fully extended position. If the central section 56 of the injection pin 50 was the same diameter as the acting end 52, as is the case for injection pin 612 shown in FIG. 1, then the injection pin would be pinched in the compacted tobacco cavity 118 between the slideable compacting plate 102 and the corresponding compacting plate 108. The reduced diameter of the central section 56 of the injection pin 50 prevents the injection pin from being pinched.

By the time the injection pin 50 retracts from the filling tube and the acting end 52 reaches a forward end 124 of the compacted tobacco cavity 118, the force input member 340 has retracted the force multiplying linkage off of the center stop 350 and past its fully extended position, and is moving towards its most retracted position. As such, the slideable compacting plate 102 has moved from its most distal position and continues to move in the direction of arrow 198, FIG. 3A, thereby allowing enough room for the acting end 52 to pass through the compacted tobacco cavity 118 without being pinched.

Another way to prevent the slideable plate 102 from pinching an injection pin is to prevent the slideable plate 102 from moving in the direction of arrow 197 during the return stroke by use of a split force output member.

As shown in FIG. 3B, a force multiplying linkage 306 can have a second force output member 314 and a first force output member 363 made from a first link 364 having a first end 366 and a second end 368 and a second link 370 having a first end 372, a second end 374, a first side 373, and a second side 375. The first link 364 may have a lower corresponding link 365 and the second link 370 may have a lower corresponding link 371. FIG. 3B shows the first link 364 and the second link 370 in the fully extended position. A pivotable connector 376 passing through a hole in the first end 316 of the second force output member 314 and a hole in the first end 366 of the first link 364 pivotably connects the first end 366 of the first link 364 to the first end 318 of the second force output member 314. The pivotable connector 376 also pivotably connects the first end 341 of the force input member 340 to the force multiplying linkage. Here, the pivotable connector is a bolt and a nut, but other pivotable connectors, such as pins, may also be used.

The second end 368 of the first link 364 is pivotably connected to the first end 372 of the second link 370 by a pivotable connector 378. Here, the pivotable connector 378 is a bolt, but another pivotable connector, such as a pin, may also be used. The second end 374 of the second link 370 is pivotably connected to the first linkage connector 322 by a pivotable connector 382 passing through an eye in the linkage end 323 of the first linkage connector 322 and through a hole in the second end 374 of the second link 370. The acting end 325 of the first linkage connector 322 is connected to the linkage support 320. Here, the pivotable connector 382 is a bolt, but another pivotable connector, such as a pin, may also be used.

As shown in FIGS. 3B and 3D, a first stop 380 is affixed to the second side 375 of the second link 370. Here, the first stop 380 is a stop pin that is affixed to the second link 370 and passes through the second link 370. A portion 386 of the first stop 380 extends beyond a lower surface 384 of the second link 370. A second stop pin 381 may be included in the lower corresponding link 371. An outer angle theta is defined by the first link and the second link. When the first link 364 and the second link 370 are in the fully extended position, a lower portion 386 of the first stop 380 rests against the second end 368 of the first link 364 at a stop point 388, thereby limiting the angle theta. Typically the angle theta is limited to between 150 and 210 degrees, more typically between 160 and 200 degrees, more typically between 170 and 190 degrees, more typically between 175 and 185 degrees, and most typically between 178 and 183 degrees. FIG. 3B shows an angle theta that is approximately 180 degrees.

A first travel limiter 392 is positioned adjacent the center stop 350 and stops the pivoting travel of the second link 370 about the pivotable connector 382 and the first linkage connector 322. The pivoting travel is stopped when a front end 393 of the first travel limiter 392 contacts the first side 373 at the front end 372 of the second link 370 at an approximate location 371 while the force input member 340 is moved in the direction of arrow 394. Typically, the first travel limiter stops the pivoting travel of the second link 370 about the pivotable connector 382 when the pivotable connectors 376, 378, and 382 are aligned, resulting in the first end 366 of the first link 364 and the second link 370 being at their fully extended position, creating an angle theta of 180 degrees. But the first travel limiter may stop the pivoting of the second link at other positions also.

FIG. 3C shows that as the force input member continues to move in the direction of arrow 394 after the second link 370 has been stopped by the first travel limiter 392, the angle theta between the first link 364 and the second link 370 is reduced. Here, the angle theta becomes less than 180 degrees. Additionally, an angle phi that was 180 degrees when the second force output member 314, the first link 364 and the second link 370 were in there fully extended positions, becomes less than 180 degrees as shown in FIG. 3C. With the angles theta and phi less than 180 degrees, the first link 364, second link 370 and second force output member 314 are not at their fully extended positions and the slideable compacting plate 102 has retracted from its most distal position.

When the force input member 340 retracts, the first link 364 and the second link 370 remain pivoted at an angle theta of less than 180 degrees. And because they are free to pivot inwardly more, the angle theta may be further reduced. As such, the first force output member 308, the first link 364, and the second link 370 do not return to their fully extended position during the return stroke of the force input member 340. Thus, the slideable compacting plate 102 does not move to its most distal position during the return stroke of the force input member 340, thereby preventing it from binding an injection pin in the compacted tobacco cavity 118.

FIG. 3E shows that during the return stroke of the force input member, the second link 370 encounters a second travel limiter 396, which limits the pivoting travel of the second end 374 of the second link 370 on the pivot 382. As a face 397 of the second travel limiter 396 interacts with the second side 375 of the second link 370, the pivoting travel is stopped. As the force input member continues to retract in the direction of arrow 398, the first link 364 rotates in the direction of arrow 395 until the lower portion 386 of the first stop 380 rests against the second end 368 of the first link 364 at a stop point 388. The force input member is then typically in a fully retracted position as shown in FIG. 3F.

Instead of the first force output member having a first and second link to prevent the slideable plate 102 from moving in the direction of arrow 197 during the return stroke of the force input member 340, the second force output member 314 may have a first and second link operating in a manner similar to the first and second link of the first force output member. Additionally, both the first force output member and the second force output member may each have a first and second link to prevent the slideable plate 102 from moving in the direction of arrow 197 during the return stroke of the force input member 340.

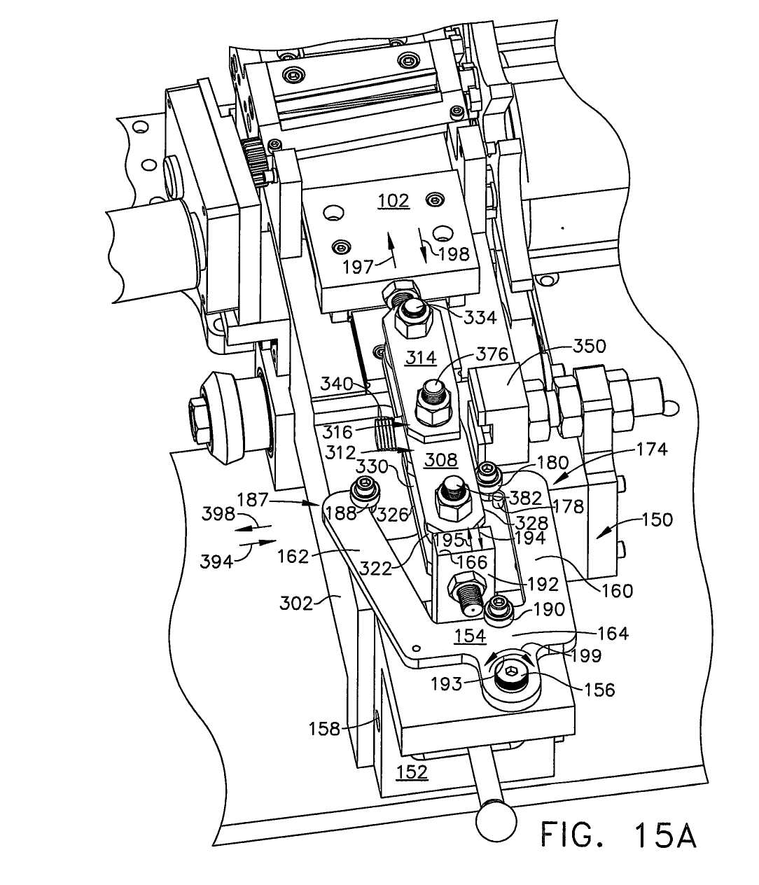

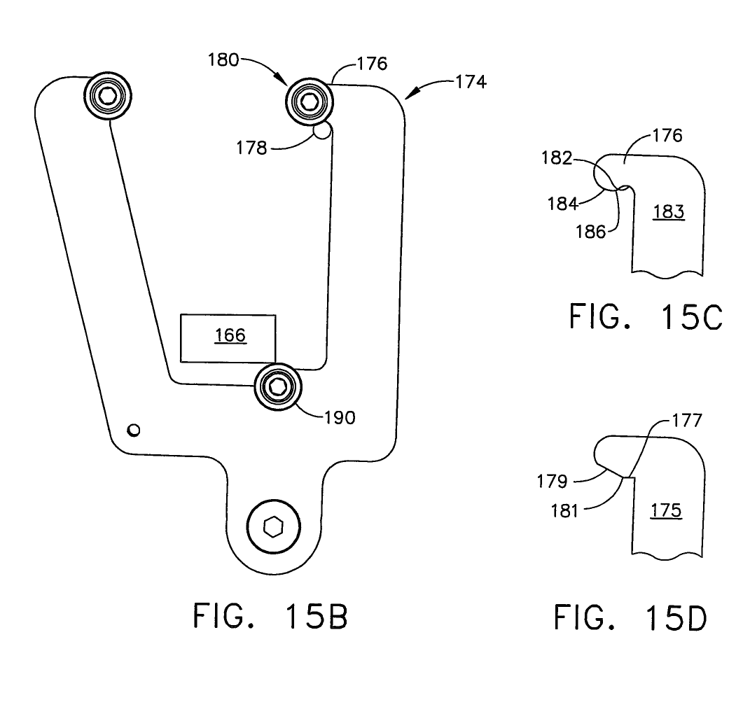

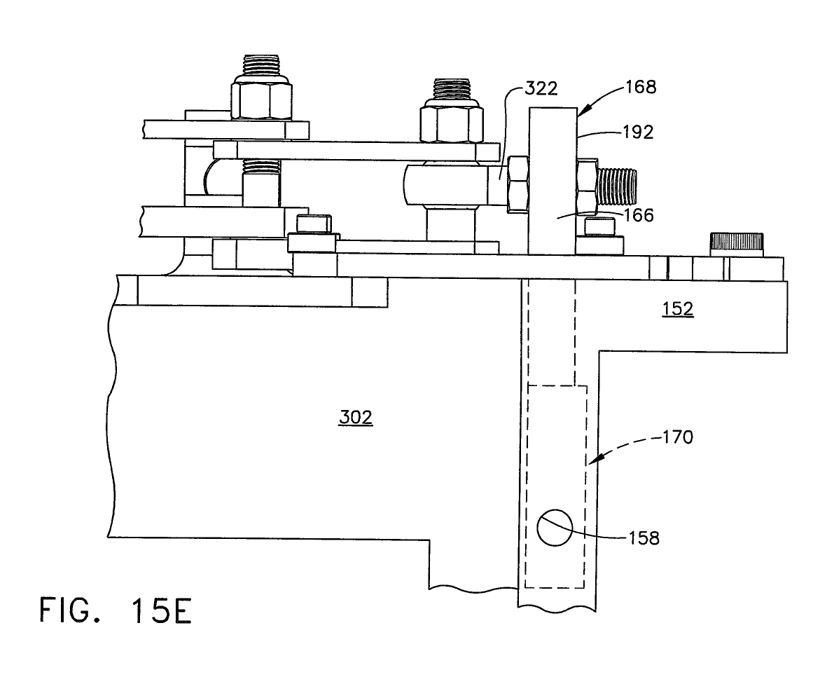

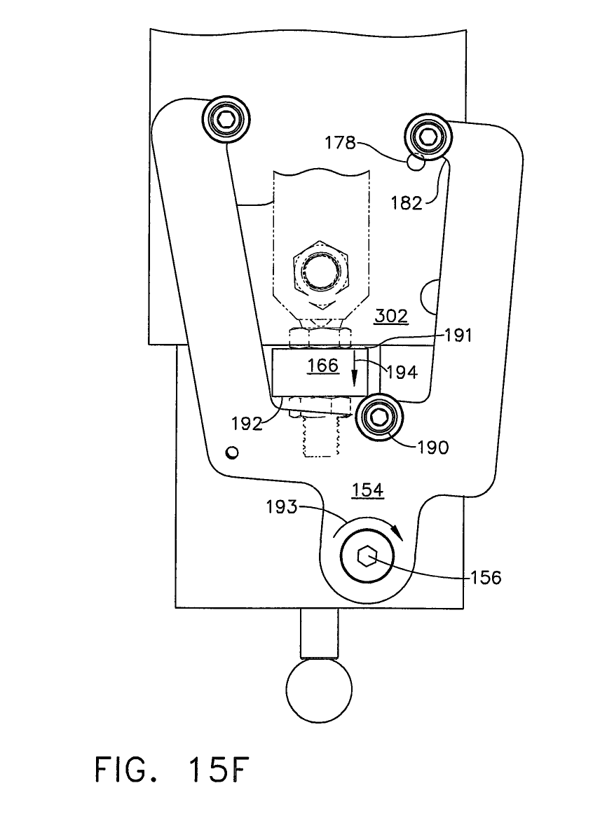

FIGS. 15A through 15F show another way that the first force output member 308 and the second force output member 314 may be configured to prevent the slideable plate 102 from moving in the direction of arrow 197 during the return stroke of the force input member 340. A linkage support locking device 150 having a U-shaped pivoting locking portion 154 with an end section 164 is pivotably mounted to the supporting frame 302 by way of a supporting flange 152 with a pivot pin 156.

The U-shaped pivoting locking portion 154 has a first leg 160 and a second leg 162 that straddle the first force output member 308 and a linkage support 166. The first leg 160 is adjacent to a first side 328 of the force multiplying linkage and the second leg 162 is adjacent to a second side 326 of the force multiplying linkage. The linkage support 166 has an upper end 168 that is connected to the first force output member 308 by way of the first linkage connector 322 and a lower end 170 that is hingeably connected to the supporting frame by hinge 158. A distal end 174 of the first leg 160 has a hook 176 that locks about a pin 178 mounted in the supporting frame 302 and a roller 180 that is coplanar with the corresponding link 330 and interacts with the first side 328 of the force multiplying linkage (see FIGS. 15A, 15B). One embodiment of a hook 176 is shown by portion 183 and has a pin receiving portion 182 for receiving the pin 178 and an inclined portion 184 (see FIG. 15C). The pin receiving portion 182 may be semicircular with a knob 186 for holding the pin 178. Another embodiment of the hook is shown by portion 175 in FIG. 15D. Here, the hook has an inclined portion 179, a knob or transition point 181, and a pin receiving portion 177.

Referring back to FIG. 15A, a distal end 187 of the second leg 162 has a roller 188 that is coplanar with the corresponding link 330 and interacts with the second side 326 of the force multiplying linkage. The end section 164 of the U-shaped pivoting locking member 154 has a roller 190 that interacts with the linkage support 166.

When the force input member 340 is in a fully retracted position, the second side 326 of the force multiplying linkage rests against the roller 188, and the pin 178 is located in the pin receiving portion 182. The roller 190 interacts against a backside 192 of the linkage support 166, preventing the linkage support 166 from moving in the direction of arrow 194.

As the force input member 340 moves in the direction of arrow 394, the first force output member 308 and the second force output member 314 push the slideable compacting plate 102 in the direction of arrow 197 and arrive in their fully extended position where the pins 376, 334, and 382 are aligned and the pin 376, the second end 312 of the first force output member 308, and the first end 316 of the second force output member 314 are in the center position. The fully extended position of the first force output member 308 and the second force output member 314 also correspond to the slideable compacting plate 102 being at its most distal position, thereby fully compacting the tobacco in the compacted tobacco cavity 118.

As the force input member 340 continues to move in the direction of arrow 394, the pin 376, the second end 312 of the first force output member 308, and the first end 316 of the second force output member 314 move over center towards the center stop 350. As the pin 376, second end 312, and first end 316 move over center, a first side 328 of the force multiplying linkage 300 contacts the roller 180. Also, once the pin 376, second end 312, and first end 316 move over center, they pull the slideable compacting plate in the direction of arrow 198 away from its most distal position. Continued motion of the force input member 340 in the direction of arrow 394 causes the first side 328 of the force multiplying linkage 300 to push against the roller 180, pivoting the U-shaped pivoting locking portion 154 about the pivot 156, and disengaging the pin 178 from the pin receiving portion 182. As the U-shaped pivoting locking portion 154 pivots in the direction of arrow 193, the roller 190 moves away from backside 192 of the linkage support 166. The linkage support 166 is then free to pivot about the hinge 158 and move in the direction of arrow 194.

FIG. 15F shows the U-shaped pivoting locking portion 154 pivoted about the pivot 156 in the direction of arrow 194. Also shown is pin receiving portion 182 having moved away from the pin 178 and the roller 190 having moved away from the backside 192 of the linkage support 166, thereby allowing the linkage support to pivot in the direction of arrow 194. A gap 191 can then be observed between the linkage support 166 and the supporting frame 302.

As the force input member 340 moves in the direction of arrow 398 on the return stroke, the pivoting action of the linkage support 166 in the direction of arrow 194 allows the slideable compacting plate 102 to maintain its current position rather than returning to its most distal position when the first force input member 308 and the second force input member 314 are in their most extended positions. Thus, pivoting action of the linkage support 166 prevents the slideable plate from pinching the injection pin.

As the force input member 340 continues retracting in the direction of arrow 398, the second side 326 contacts the roller 188. Continued motion of the force input member 340 in the direction of arrow 398 causes the second side 326 of the corresponding force output member 330 to push the roller 188, and thus the distal end 187 of the second leg, in the direction of arrow 398. The U-shaped pivoting locking portion 154 then pivots about pivot 156 in the direction of arrow 199, causing the roller 190 to push the linkage support 166 in the direction of arrow 195 as it moves back against the backside 192 of the linkage support 166. When the force input member 340 reaches its retracted position, the pin 178 rests in the pin receiving portion 182 and the roller 190 rests against the backside 192 of the linkage support 166, preventing it from moving in the direction of arrow 194 during the next forward stroke of the force input member.

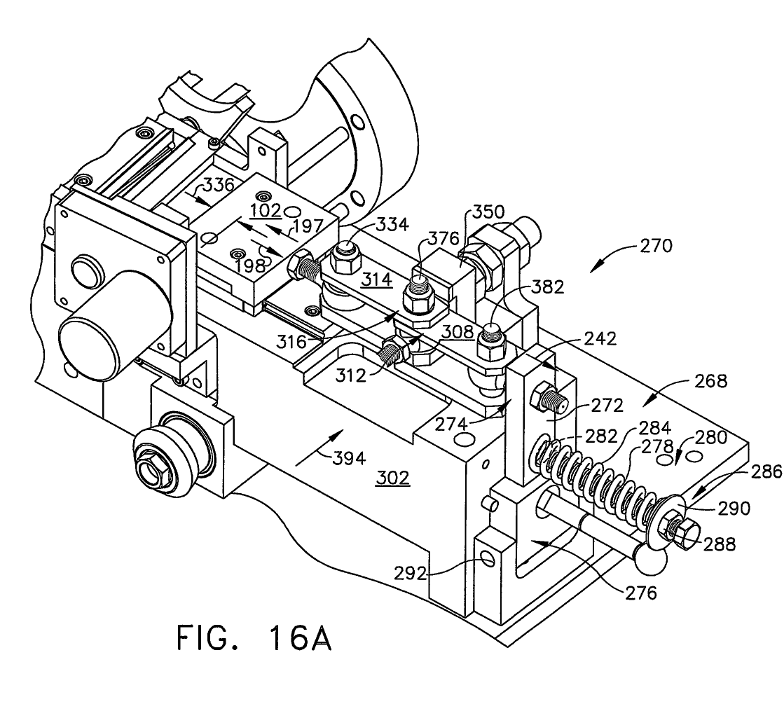

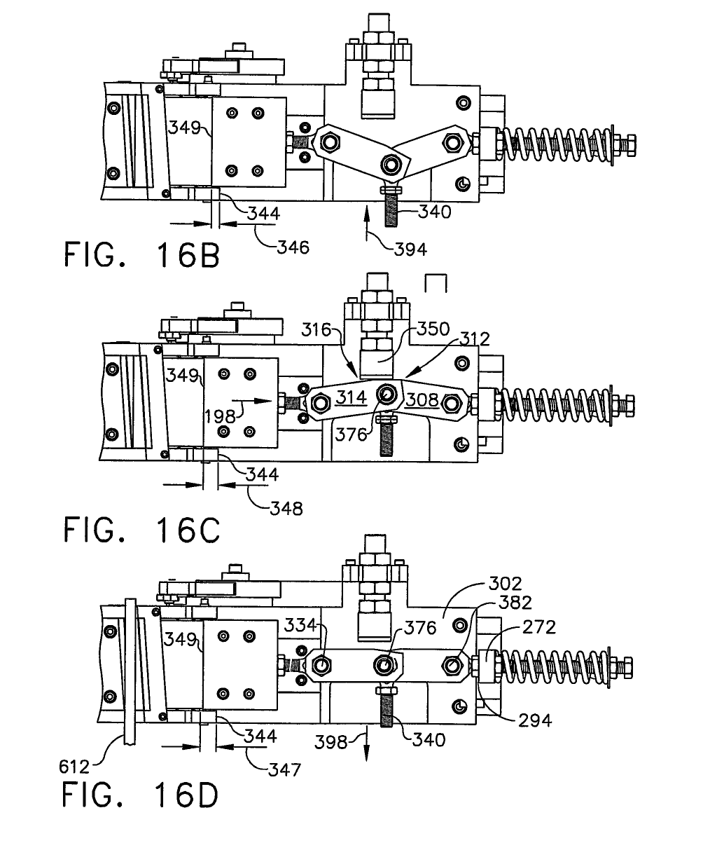

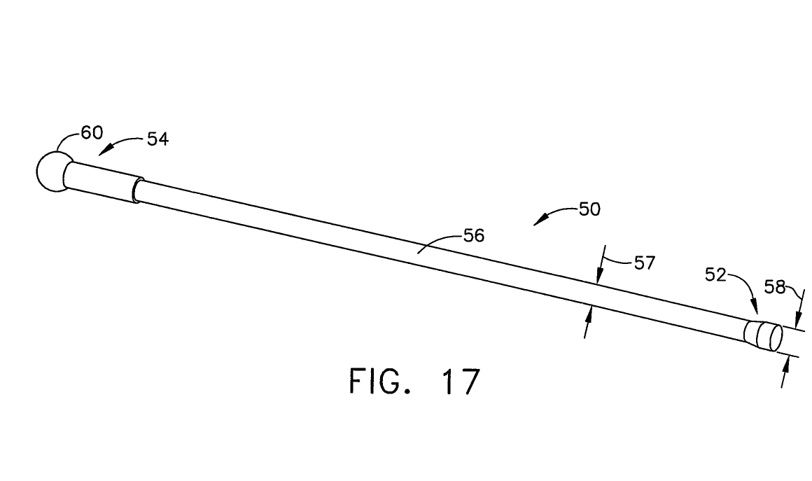

FIG. 16A shows another type of mechanism that may be used to prevent the slideable compacting plate 102 from pinching an injection pin in the compacted tobacco cavity 118 on the return stroke of the force input member 340. A spring-retained linkage support system 270 has a hinged linkage support 272 with a linkage end 274 and a hinged end 276. The hinged end 276 is pivotably connected to the supporting frame 302 by a hinge 292. A spring holder 268 has a rod 278 having a distal end 286 with a spring retainer 280 and an opposite end that passes through a hole 282 in the hinged linkage support 272 and is affixed to the supporting frame 302. Here, the rod is threaded into the supporting frame 302, but other methods of affixing the rod to the supporting frame, such as welding, may also be used. The spring retainer 280 biases a spring 284 against the hinged linkage support 272.

The spring retainer 280 has a nut 288 and a washer 290. The pressure the spring exerts on the hinged linkage support 272 may be adjusted by way of threading the nut 288 in or out on the threaded distal end 286 of the rod 278.

In FIG. 16B, the force input member 340 is shown in a fully retracted position. In the fully retracted position, the distance between a reference point 344 and a front edge 349 of the slideable compacting plate 102 is shown as 346. As the force input member 340 moves in the direction of arrow 394, the first force output member 308 and the second force output member 314 push the slideable compacting plate 104 in the direction of arrow 197 and arrive in their fully extended position where the pins 376, 334, and 382 are aligned and the pin 376, the second end 312 of the first force output member 308, and the first end 316 of the second force output member 314 are in the center position (see FIG. 16A). The fully extended position of the first force output member 308 and the second force output member 314 also correspond to the slideable compacting plate 102 being at its most distal position with a distance 336 being greater than the distance 346, thereby compacting the tobacco into a tobacco plug. The spring 284 exerts sufficient pressure on the hinged linkage support 272 to compact the tobacco in the compacted tobacco cavity 118 before the hinged linkage support 272 pivots away from the supporting frame in the direction of arrow 242.

As the force input member 340 continues to move in the direction of arrow 394, the pin 376, the second end 312 of the first force output member 308, and the first end 316 of the second force output member 314 move over center towards the center stop 350. As shown in FIG. 16C, once the pin 376, second end 312, and first end 316 move over center, they pull the slideable compacting plate in the direction of arrow 198 away from its most distal position, resulting in a distance 348 being less than the distance 336. The pin 376, the second end 312 of the first force output member 308, and the first end 316 of the second force output member 314 then rest against the center stop 350.

FIG. 16D shows the fully extended position of the force multiplying linkage when the force input member 340 is on its return stroke. Concurrently, an injection pin 612 has moved into the compacted tobacco cavity 118 to inject a tobacco plug into a filling tube (not shown). As the force multiplying mechanism moves to the fully extended position, the slideable compacting plate 102 moves against the injection pin 612. When the slideable compacting plate 102 hits the injection pin 612, spring 284 compresses to allow the hinged linkage support 272 to pivot away from the supporting frame 302 on the hinge 292 so that the slideable compacting plate 102 does not bind the injection pin in the compacted tobacco cavity. A gap 294 shows that the hinged linkage support 272 has pivoted away from the supporting frame 302. Typically a distance 347 is less than the distance 336 by an amount equal to a gap 294 between the supporting frame 302 and the hinged linkage support 272. As the force input member 340 continues to move in the direction of arrow 398, the slideable compacting plate 102 pulls away from the injection pin 612 and the spring biases the hinged linkage support 272 against the supporting frame 302.

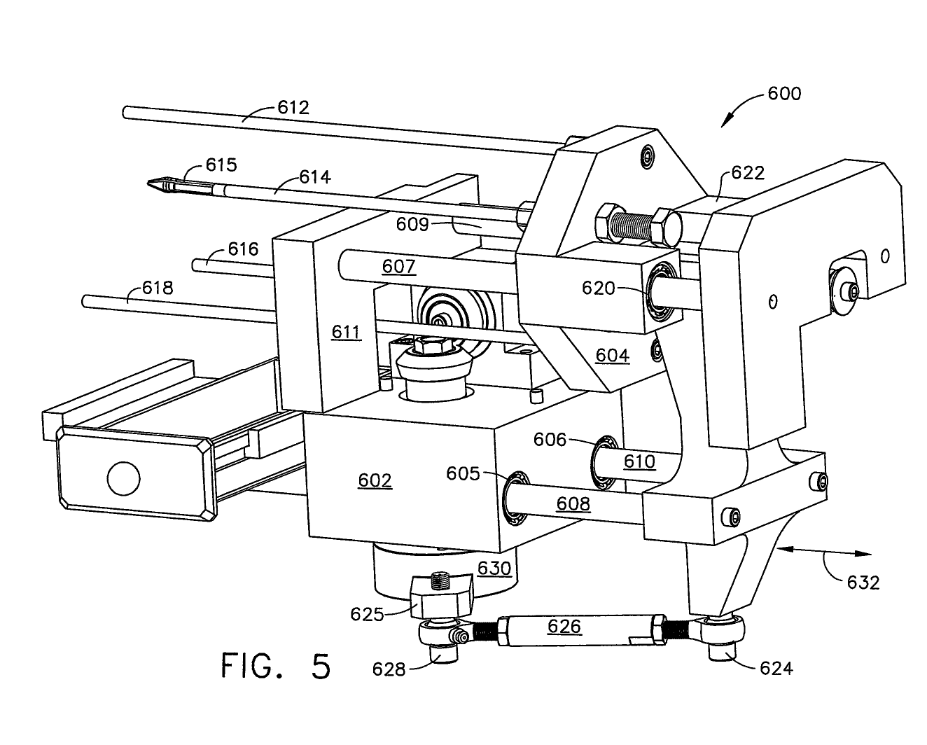

FIG. 1 shows a pin mechanism 600 affixed to the base 12. As shown in FIG. 5, the pin mechanism 600 has a pin carrier support structure 602 having slide receivers 605 and 606 and slides 607 and 609. Slides 607 and 609 are affixed to a vertical portion 611 of the pin carrier support structure 602. A slideable pin carrier 604 having slide receivers 620 and 622 and slides 608 and 610 is slideably mounted to the pin carrier support structure 602 by way of slides 608 and 610 passing through slide receivers 605 and 606 and slides 607 and 609 passing through slide receivers 620 and 622.

Arm 626 connects a drive pin 624 to a pin 628 that is offset a distance from the center of a wheel 630 by arm 625. As the wheel 630 rotates, the rotational motion is converted to a linear motion by arm 626, thereby driving the slideable pin carrier 604 back and forth as shown by double arrow 632.

The slideable pin carrier 604 has a plurality of pins, including an injection pin 612, a guide pin 614 having a guide head 615, an ejection pin 616, and a cleaning pin 618. The slideable pin carrier may have more or less pins, depending on the needs of the tobacco making machine. Typically, during operation, the injection pin 612 is aligned with the compacted tobacco cavity 118.

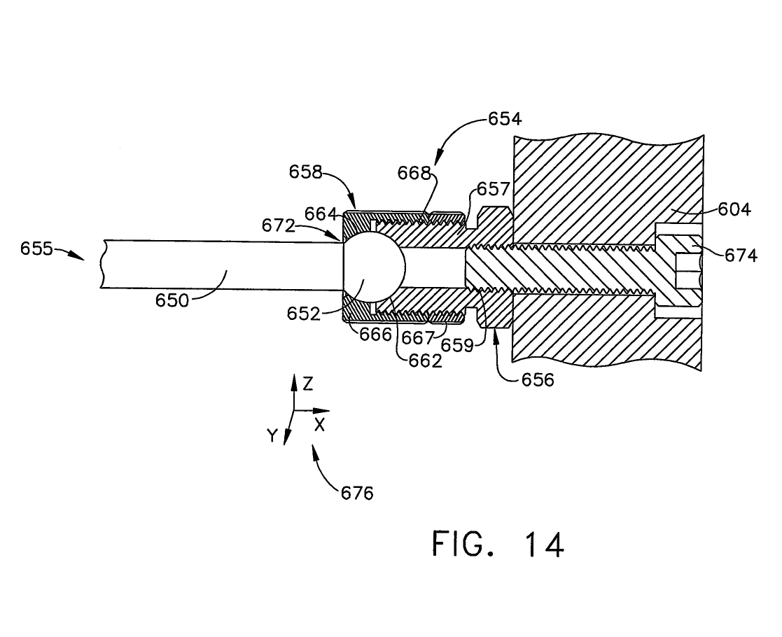

The pins typically slide through the filling tubes, and as they do so they may rub against the sides of the filling tubes if they are too rigid. One way to reduce friction between the pins and the filling tubes is to allow the pins to pivot on the slideable pin carrier. One apparatus utilizes a ball and socket joint to allow the pins to pivot. FIG. 14 shows a connector 654 having a mounting end 656 and a connecting end 658. The connecting end 658 includes a nut 666, a locknut 667, a male-threaded portion 657 for receiving the nut 666, and a first semicircular portion 662. The nut 666 has female threads 668 and a second semicircular portion 664. The first semicircular portion 662 and the second semicircular portion 664 define a socket 672 in the connecting end. The mounting end 656 contains female threads 659 for receiving a bolt 674 which affixes the connector 654 to the slideable pin carrier 604. Other methods of affixing the mounting end 656 of the connector 654 to the pin carrier may also be used.

FIG. 14 shows a representative pin 650 having an acting end 655 and a connecting end 652. Depending on the configuration of the acting end of the pin, the pin may be a guide pin 614, an injection pin 612, a cleaning pin 618, an ejection pin 610, or any other type of pin. Here, the connecting end is a ball sized to fit in the socket 672. The ball and socket design allows the pin two degrees of freedom, as represented by the y and z axis of 676. Alternatively, other means of connecting the connecting end of the pin to the slideable pin carrier may also be used to provide two degrees of freedom to the pin. For example, instead of the connecting end of the pin 650 having the ball and the connecting end of the connector having a socket, the connecting end 652 of the pin may have a socket and the connecting end of the connector may have a ball. Also, other methods of connecting a pin to the pin carrier, such as a spring, may also be used to provide two or more degrees of freedom to the pin.

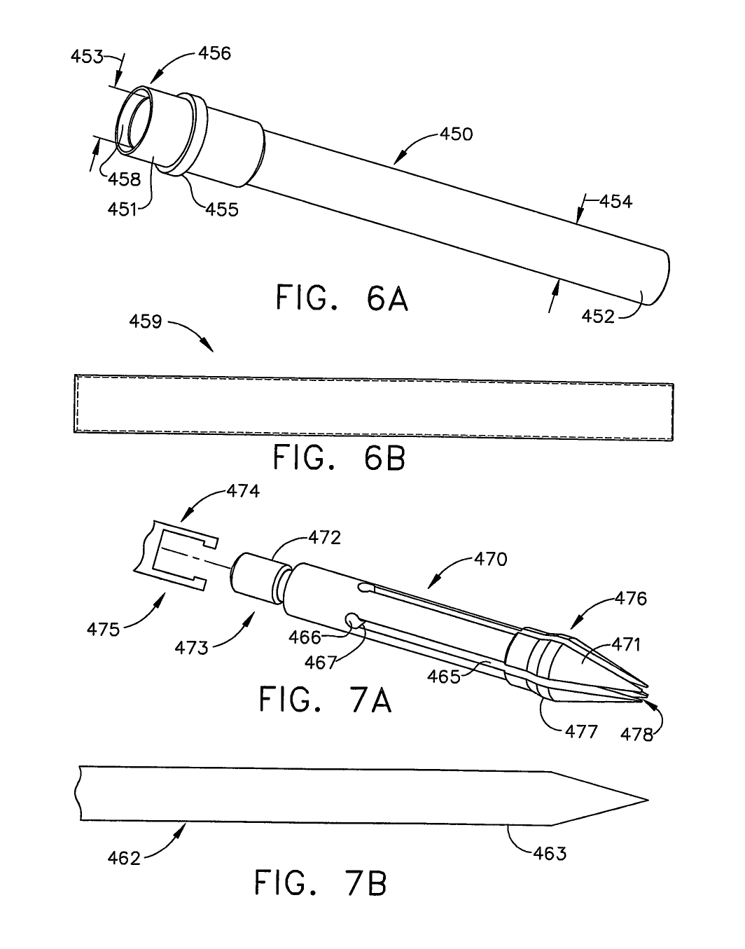

FIG. 6A illustrates a filling tube 450 having a first end 451, a second end 452, an inside diameter 453, and an outside diameter 454. Other shapes of tubes may be used as filling tubes, including square or octagonal shaped tubes. The first end 451 of the filling tube may have a shoulder 455 for securing the filling tube 450 to a filling tube holder (not shown). Alternatively, a filling tube may be secured to a filling tube holder (not shown) by other means, such as press fit, welded, or threaded connections. FIG. 6B shows an embodiment of the filling tube 459 without a shoulder that may be press fit or welded to a filling tube holder (not shown). The first end 451, may have a taper 458 from the first end 451 outside diameter 456 to the inside diameter 453 for receiving a guide head 470.

FIG. 7A illustrates an embodiment of a guide head 470. The guide head 470 has a distal end 471 and a proximal end 472 and is sized to fit within the inside diameter 453 of the filling tube 450. The proximal end 472 of the guide head 470 has fastening means 473 for attaching the guide head 470 to a pin 474 having a complimentary fastening means 475. The fastening means 474 and 475 can be a threaded connection, a press fit, or other methods known to those of ordinary skill in the art. Additionally, the guide head 470 and the pin 474 may be fabricated from a single piece of material. The distal end 471 of the guide head 470 has a substantially conical head 476. A largest diameter 477 of the conical head 476 is typically equal to or greater than the outer diameter 454 of the filling tube 450. Therefore, the conical head 476 is collapsible to enable it to pass through the filling tube 450 and exit out the second end 452 of the filling tube 450.

Various means may be used to provide a collapsible guide head. In the embodiment 470 shown in FIG. 7A, a plurality longitudinal slots 465 are cut from a tip 478 of the conical head 476 to a slot termination location 467. The slots typically terminate at a radius 466 to reduce stresses that the slots may induce into the guide head material and thereby prevent self propagation of the slots toward the proximal end 472 of the guide head 470. The guide head 470 may be made from a variety of materials, including plastics and metals. Typically, one may use a hardened steel, such as 01 steel hardened to 58-60 Rockwell C, for the guide head. Other means, such as a flexible rubber guide head, a polymer guide head, or an inflatable guide head may be used to produce a collapsible guide head.

FIG. 7B illustrates an embodiment of a pin 462 with guide head 463 in which the outside diameters of the pin 462 and the guide head 463 are equal to or less then the inside diameter 453 of the filling tube 450. In this embodiment, the guide head 463 does not need to collapse to pass through the filling tube 450.

FIG. 8A shows a filling tube holder 400 comprising a drum 401 having a first end 402 and a second end 403. The first end 402 of the drum 401 has a plurality of holes 404 and 405 for receiving a plurality of filling tubes 450. Other holes (not shown) for receiving filling tubes may also be disposed on the first end 402 of the drum 401.

This description describes filling tube 450 and the features in the drum 401 associated with filling tube 450. Other filling tubes mounted in the drum will typically be mounted in a similar manner, and the drum typically will have similar features for each of the other filling tubes. One method of attaching a filling tube 450 to a drum 401 is a clamping device 408 for clamping against the shoulder 455 on the first end 451 of the filling tube 450. Alternatively, other means for attaching the filling tubes to a filling tube holder may be used. For example, the filling tubes and the plurality of holes in the holder for receiving the filling tubes may be threaded. Also, the filling tubes may be threaded to receive a nut after passing through a hole in the drum. Additionally, other methods instead of a drum may be used for holding a plurality of tubes, for instance, the filling tubes may be mounted on a plate or on a belt.

Axially aligned with the filling tube hole 404 is a conical directing hole 411 having a proximal end 412 and a distal end 413. The distal end 413 of the cone shaped hole defines the larger diameter of the cone, and the diameter of the proximal end of the cone shaped hole is slightly larger than the outside diameter of a blank cigarette tube (discussed later).

FIG. 8B is a partial section view of the drum 401 having the filling tube 450 into which the guide head 470, typically attached to a pin (not shown), is passing. As the conical head 476 of the guide head 470 passes into the first end 451 of the filling tube 450, the filling tube 450 squeezes the guide head 470, thereby collapsing guide head 470 and allowing the largest diameter 477 of the guide head 470 to be less than the inside diameter 453 of the filling tube 450.

FIG. 8C is a partial section view of the drum 401 having the filling tube 450 through which the conical head 476 of the guide head 470, typically attached to a pin (not shown), has passed. The conical head 476, having passed through the second end 452 of the filling tube 450, can be observed in its relaxed state with the large diameter 477 of the guide head 470 now equal to or greater than the outside diameter 454 of the filling tube 450.

FIG. 8D illustrates a blank cigarette tube 425 being loaded onto the filling tube 450. The conical head 476 extends beyond the filling tube 450. The blank cigarette tube loader 700 (described later) induces a force on a filter end 426 of a blank cigarette tube 425, causing the blank cigarette tube 425 to move toward the conical head 476 of the guide head 470. In this illustration, an open end 427 of the blank cigarette tube 425 has been damaged, resulting in the normal circular shape of the end of the blank cigarette tube 425 becoming oblong. As the blank cigarette tube 425 moves toward the guide head 470, the proximal end 412 of the conical hole 411 in the drum 401 will operate to return the oblonged open end 427 of the blank cigarette tube 425 to a more circular shape. The blank cigarette tube 425 continues through the conical hole 411, over the conical head 476, and then onto the filling tube 450.

FIG. 8E is similar to FIG. 8D, with the exception that the blank cigarette tube 425 has been fully inserted on the filling tube 450. Thereafter, the guide head 470 is removed from the filling tube 450 by withdrawing it out through the first end 451 of the filling tube 450. The filling tube 450 and blank cigarette tube 425 are then ready to receive the tobacco plug 265 prepared by the previously discussed tobacco compaction mechanism 100.

FIG. 8G illustrates an ejection pin 616 ejecting a completed cigarette tube 430, having been filled with a tobacco plug 265, from the filling tube 450.

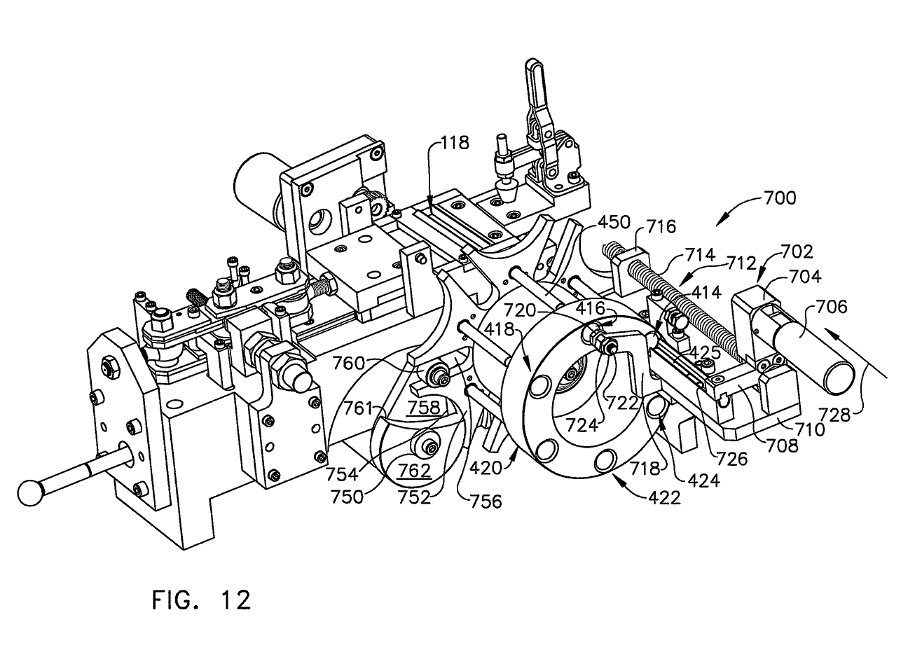

As shown in FIG. 12, the drum is driven and timed with a Geneva drive. Other types of driving and timing mechanisms may also be used. The Geneva drive translates the continuous rotary motion of a drum drive shaft 750 into intermittent rotary motion. The drum has a plurality of drum plates 752 with semicircular cutouts 754 and a slot 756 between each plate. A drive wheel 758 has a roller 760 with a diameter corresponding to the width of the slots 756 and a semicircular plate 762 with dimensions corresponding to the semicircular cutouts of the drum plates. As the drive wheel rotates, the roller 760 enters slot 756, thereby rotating the drum forward. As the drive wheel continues to rotate, the roller exits the slot, and a leading edge 761 of the semicircular plate 762 engages in the semicircular cutout 754, holding the drum in position until the pin engages the next slot and the process is repeated.

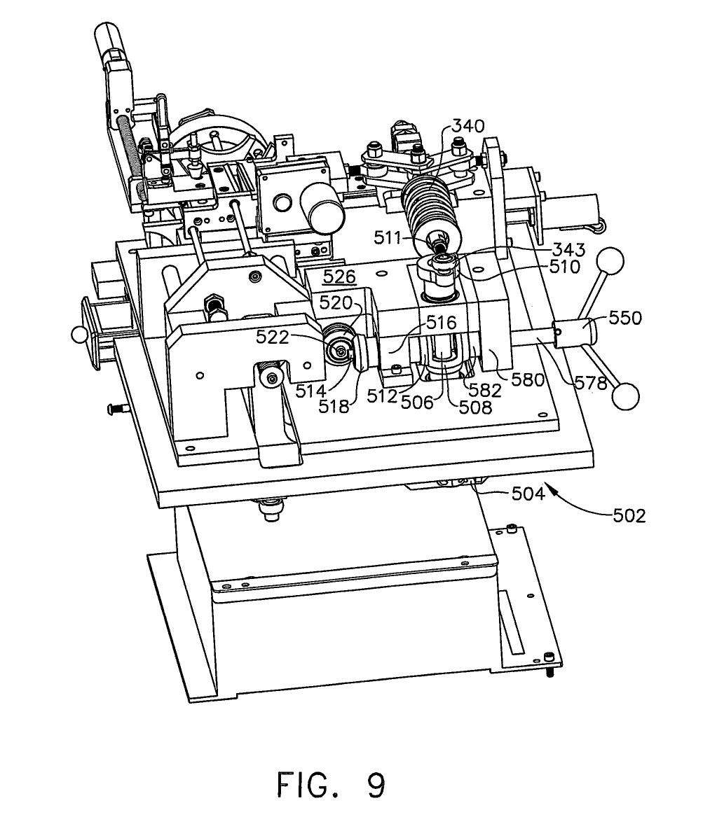

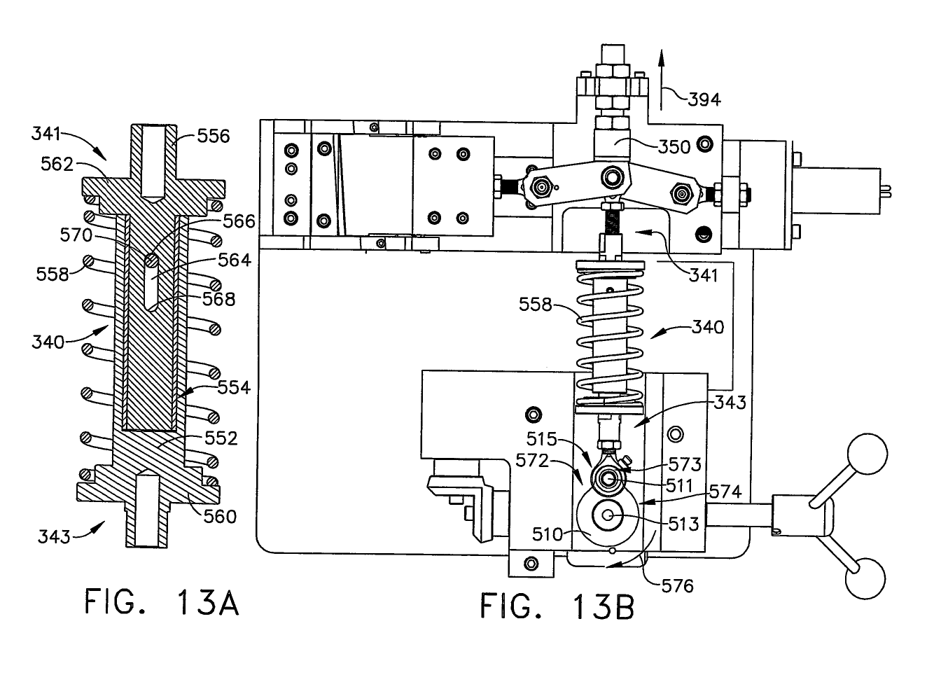

Referring now to FIG. 9, in operation, a motor 502 drives a gear reducer 504. An output shaft 506 from the gear reducer 504 has a first beveled gear 508 and a force input member wheel 510 mounted to it. As shown in FIG. 13B, the wheel 510 has a center 513 and a force input member arm 515 having a pin 511 that is offset a distance from the center of the wheel. The second end 343 of the force input member 340 is pivotable connected to the arm 515 by pin 511. The force input member 340 has a dwell mechanism that allows the force multiplying linkage to be at an over center position against the center stop 350 for a predetermined period of time during continued rotation of the wheel 510. One method of incorporating dwell is using a spring loaded force input member 340.

FIG. 13A shows a force input member 340 that is collapsible to allow a dwell time for the force multiplying linkage. The force input member 340 includes a first portion 552 with a receiving section 554 that slideably receives a second portion 556. A spring 558 is disposed between a first retainer 560 that is attached to the first portion 552 and a second retainer 562 that is attached to the second portion 556. The second portion 556 has a slot 564 having a first end 566 and a second end 568 sized to receive a pin 570 that is attached to the first portion 552. The force input member 340 shown in FIG. 13A is in the collapsed position, as indicated by the pin 570 resting against the first end 566 of the slot 564. When the force input member 340 is in the extended position, the pin 570 will rest against the second end 568 of the slot 564.

FIG. 13B shows the second end 343 of the force input member 340 connected to a pin 511 of the wheel 510 and the first end 341 of the force input arm 340 connected to the force multiplying linkage 300. As the wheel 510 rotates in the direction of arrow 576, the force input arm 340 is typically in the extended position until the pin 511 reaches a location 572. When the pin reaches the location 572, the force multiplying linkage hits the center stop 350, which prevents further travel of the force multiplying linkage in the direction of arrow 394. As the wheel 510 continues to rotate, the spring 558 is compressed. The force input arm 340 is in a compressed position, as shown in FIG. 13A, when the pin reaches a location 573. The spring remains compressed until the pin 511 of the wheel 510 reaches a location 574, by which time the force input member 340 has returned to its extended position. The collapsible force input member 340 allows the force multiplying linkage to remain, or dwell, in its position against the center stop 350 as the pin 511 moves from location 572 to location 574.

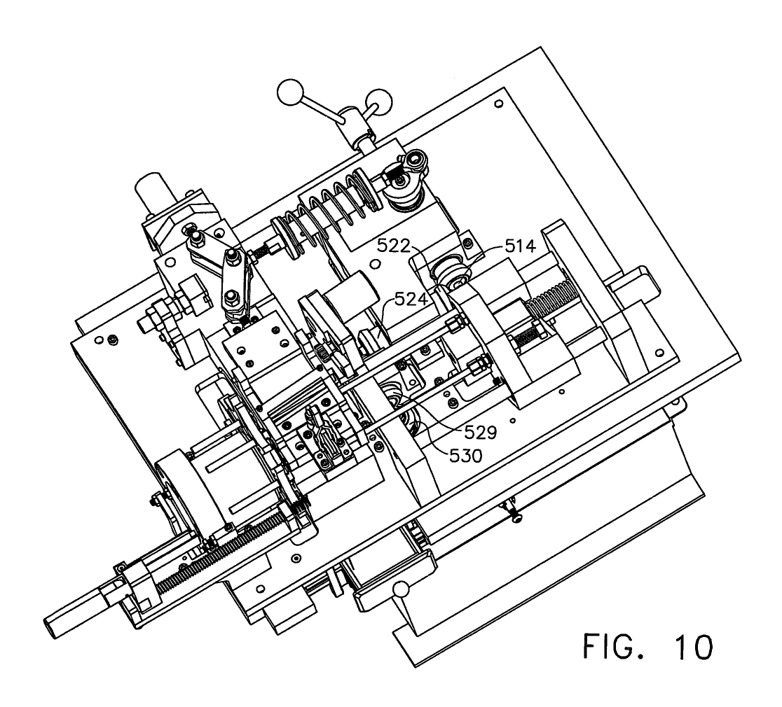

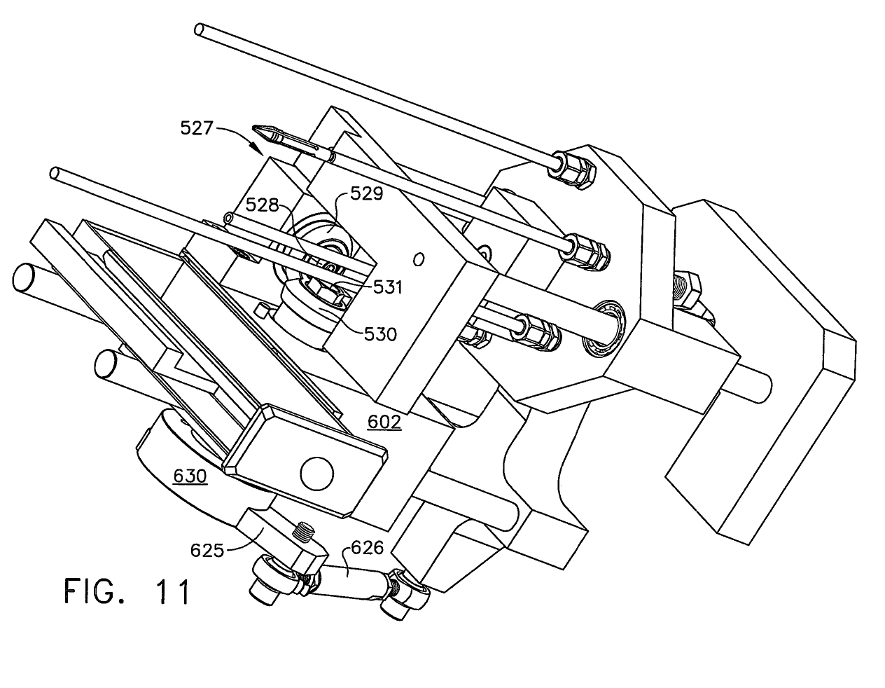

Referring to FIGS. 9 through 11, the first beveled gear 508 drives a second beveled gear 512 that is attached to a shaft 514. The shaft 514 passes through shaft support 516 and has a third beveled gear 518 affixed to it opposite the second beveled gear 512. The third beveled gear 518 mates with a fourth beveled gear 520 that is mounted on a shaft 522. The shaft 522 passes through shaft support 526 and has a fifth beveled gear 524 affixed to it.

A sixth beveled gear 527 (not shown) meshes with the fifth beveled gear 524 and is affixed to one end of a shaft 528. A seventh beveled gear 529 is affixed to the shaft 528 opposite the beveled gear 527. An eighth beveled gear 530 meshes with the seventh beveled gear 529 and is affixed to a shaft 531 that passes through the pin carrier support 602 and has a wheel 630 with an arm 625 affixed to it opposite the sixth beveled gear 530. The arm 625 is connected to the slideable pin carrier 604 by an arm 626. The shaft 750 that drives the drive plate 758 of the Geneva drive mechanism has a beveled gear (not shown) also interacting with the sixth beveled gear 527.

Typically, one rotation of the output shaft 506 will result in one cigarette being made. Because, the output shaft typically rotates a full revolution without stopping and some mechanisms require dwell time in certain positions, various timing and dwell mechanisms may be used.

The cigarette making machine may also be manually driven by turning a hand wheel 550. A shaft 578 passes through support 580 and connects the hand wheel 550 to a beveled gear 582. Instead of using the motor 502 to drive the cigarette malting machine, an operator may use the hand wheel 550 to drive the beveled gear 582, which in turn operates the cigarette making machine.

Other methods may also be used to drive the cigarette making machine. For example, instead of the multiple beveled gears, one motor may be used to drive the wheel 510 that operates the force input member 340 to drive the force multiplying linkage 300, one motor may be used to drive the wheel 630 that drives the slideable pin carrier, and one motor may be used to drive the driven wheel of the Geneva gear, which drives the drum 401. When multiple motors are used instead of a single motor with beveled gears to drive and time the various operations, a timing mechanism is used to synchronize the motors. The timing mechanism may be components on a PCB, a PLC, or other various sensors or timers. Also, linear actuators may be used in place of at least some of the motors. For example, a linear actuator may be used in place of the wheel 510 and the force input member 340 to drive the force multiplying linkage and a linear actuator may be used in place of the wheel 630 and arm 626 to drive the slideable pin carrier. When linear actuators are used, a timing mechanism such as timers, components on a PCB, a PLC, or other various sensors or timers may be used to synchronize the linear actuators.

FIG. 12 shows the cigarette making machine having a blank cigarette tube loader 700. The blank cigarette tube loader 700 has a slideable body 702 comprising a body 704 with a handle 706 and a pusher 708. A blank cigarette tube loader base 710 carries a guide 712 on which the body 704 slides. A spring 714 operates against a stop 716 affixed to the blank cigarette tube loader base 710. A trough 726 is sized to receive a blank cigarette tube 425.

To operate the blank cigarette tube loader, a user places a blank cigarette tube 425 into the trough 726. Then, by pushing the handle 706 in the direction of arrow 728, the pusher 708 pushes the blank cigarette tube 425 onto the filling tube 450. The spring 714 assists the user in returning the handle 706 to the start position after loading a blank cigarette tube onto a filling tube.

An arm 718 having a cigarette stop 720 may also be affixed to the blank cigarette tube loader base 710. The cigarette stop prevents a blank cigarette tube 425 from being pushed off of the filling tube 450 when it is being loaded with a tobacco plug by the injection pin 612. The stop 720 may also be adjustable. For example, the stop 720 has a bolt 722 secured with a lock-nut 724 and passing through a threaded hole in the arm 718. The cigarette stop may be mounted to structures other than the arm 718 and still perform the same function.

To operate the cigarette making machine, a user pushes a button to cause the motor 502 to drive the slideable pin carrier 604 in the direction of arrow 619 (see FIG. 1) to a forward position shown so that the guide head 615, which guides the blank cigarette tube 425 onto the filling tube 450, of the guide pin 614 passes through the filling tube 450 as shown in FIGS. 8C and 8D. The user then inserts a blank cigarette tube 425 located at a station 414 (see FIG. 12) over a filling tube 450 mounted to a drum using the blank cigarette tube loader 700. Alternatively, the user could insert the blank cigarette tube 425 over the filling tube 450 manually without using the blank cigarette tube loader.

The user then presses a start button to begin a cigarette making cycle. First, slideable pin carrier 604 retracts in the direction of arrow 621 (see FIG. 1) and the tobacco conveying device 200 conveys a predetermined amount of tobacco to the compaction area 114. The rotating output shaft 506 drives the wheel 510, causing the force input member 340 to drive the force multiplying mechanism 300. The force multiplying mechanism 300 slides the slideable compacting plate 102 in the direction of 197, causing the compacting end 104 to compact the tobacco in the compaction area 114 into a compacted tobacco plug 265 in the compacted tobacco cavity 118.

While the tobacco compaction mechanism 100 is compacting the tobacco, the Geneva drive mechanism rotates the drum 401 to move the filling tube with the previously loaded blank cigarette tube to station 416 where it is axially aligned with the compacted tobacco plug 265 located in the compacted tobacco cavity 118 (see FIG. 12).

Referring also to FIG. 1, the slideable pin carrier 604 then moves forward in the direction of arrow 619, causing the injection pin 612, which is axially aligned with the compacted tobacco cavity 118, to inject the tobacco plug 265 into the filling tube 450. Because the injection pin 612 and the guide pin 614 with the guide head 615 are both attached to the slideable pin carrier 604, the guide head passes through the filling tube located at station 414 at the same time the injection pin 612 injects the tobacco plug 265. The motor then pauses to allow the user to load another blank cigarette tube onto the adjacent filling tube.

The user again pushes the start button after loading a blank cigarette tube onto the filling tube located at station 414. The cycle of retracting the slideable pin carrier 604, conveying and compacting the tobacco, and injecting the tobacco then begins again. During this cycle, filling tube having the first loaded tube moves to location 418.

The machine pauses again to allow a user to load another blank cigarette tube onto a filling tube at location 414. Pressing the start button, another cycle is run. During this cycle, the first loaded tube moves to station 420 and a completed cigarette is ejected by the ejection pin 616 when the slideable pin carrier 604 moves in the direction of arrow 619. Alternatively, another cycle could be completed and the cigarette could be ejected at station 422.

During each cycle, the cleaning pin 617 is pushed through and cleans the filling tube located at station 424 when the slideable pin carrier 604 moves in the direction of arrow 619. Thus, the filling tube is cleaned before it moves forward to station 414, where it is loaded with a blank cigarette tube.

While the present invention has been illustrated by the description of embodiments thereof, and while the embodiments have been described in considerable detail, it is not intended to restrict or in any way limit the scope of the appended claims to such detail. Additional advantages and modifications will be readily apparent to those skilled in the art. The invention is therefore not limited to the specific details, representative apparatus and method, and illustrated examples shown and described. Accordingly, departures may be made from such details without departing from the scope or spirit of the invention.

What is claimed is:

1. A force multiplying linkage comprising
a first linkage connector having a linkage end and an acting end,
a second linkage connector having a linkage end and an acting end,
a first force output member,
a second force output member having a first end and a second end, the first end pivotably attached to the linkage end of the second linkage connector,
wherein the first force output member comprises a first link with a first end and a second end and a second link with a first end and a second end, wherein the first end of the first link is pivotably attached to the second end of the second force output member, the second end of the first link is pivotably attached to the first end of the second link, the second end of the second link is pivotably attached to the linkage end of the first linkage connector, and the first link and the second link define an angle theta,
a first stop affixed to the second link, wherein the first stop limits the angle theta to a maximum between 150 and 210 degrees when the first stop rests against the second end of the first link, and
a first travel limiter interacting with the second link, wherein the first travel limiter limits the pivoting travel of the second link on the second linkage connector, thereby reducing the angle theta.

2. The force multiplying linkage according to claim 1, further comprising a force transmitting member and a linkage support wherein the acting end of the first linkage connector is connected to the force transmitting member and the acting end of the second linkage connector is connected to the linkage support.

3. The force multiplying linkage according to claim 1, further comprising a force transmitting member and a linkage support wherein the acting end of the first linkage connector is connected to the linkage support and the acting end of the second linkage connector is connected to the force transmitting member.

4. The force multiplying linkage according to claim 2 wherein the force transmitting member is a slideable compacting plate having a linkage end and a compacting end with a compacting die, and the linkage end of the slideable compacting plate is connected to the acting end of the first linkage connector.

5. The force multiplying linkage according to claim 3 wherein the force transmitting member is a slideable compacting plate having a linkage end and a compacting end with a compacting die, and the linkage end of the slideable compacting plate connected to the acting end of the second linkage connector.

6. The force multiplying linkage according to claim 1, further comprising a collapsible force input member with a first end and a second end, and a force input member wheel having an arm, wherein the first end of the force input member is connected to the force multiplying linkage and the second end of the collapsible force in put member is connected to the arm.

7. A linkage support locking device comprising
a supporting frame,
a linkage support having a backside and pivotably attached to the supporting frame,
a force multiplying linkage having a first end, a second end, a first side, and a second side,
a first linkage connector having a linkage end connected to the force multiplying linkage and an acting end connected to the linkage support,
a second linkage connector having a linkage end and an acting end, the linkage end connected to the force multiplying linkage, and
a pivoting locking portion with a first leg, a second leg, and an end section, the end section pivotably attached to the supporting frame, the first leg located adjacent the first side of the force multiplying linkage and adapted to interact with the force multiplying linkage and having a pin receiving portion to engage a locking pin, and the second leg located adjacent the second side of the multiplying linkage.

8. The linkage support locking device according to claim 7, further comprising a roller connected to the end section and interacting with the backside of the linkage support.

9. The linkage support locking device according to claim 7 further comprising a roller connected to the first leg and interacting with the first side of the force multiplying linkage.

10. The linkage support locking device according to claim 7 further comprising a roller connected to the second leg and interacting with the second side of the force multiplying linkage.

11. The linkage support locking device according to claim 7, further comprising a force transmitting member wherein the acting end of the second linkage connector is connected to the force transmitting member.

12. The linkage support locking device according to claim 11 wherein the force transmitting member is a slideable compacting plate having a linkage end and compacting end with a compacting die the linkage end of the slideable plate connected to the acting end of the second linkage connector.

13. The linkage support locking device according to claim 7, further comprising a collapsible force input member with a first end, a second end, and a force input member wheel having an arm, wherein the first end of the force input member is connected to the force multiplying linkage and the second end of the collapsible force input member is connected to the arm.

14. A spring-retained linkage support system comprising
a supporting frame,
a hinged linkage support pivotably attached to the supporting frame,
a force multiplying linkage with a first end and a second end,
a first linkage connector having a linkage end and an acting end, wherein the linkage end is connected to the first end of the force multiplying linkage and the acting end is connected to the supporting frame,
a second linkage connector having a linkage end and an acting end, wherein the linkage end is connected to the second end of the force multiplying linkage,
a spring retainer, and
a spring disposed between the spring retainer and the hinged linkage support for biasing the hinged linkage support against the supporting frame.

15. The spring-retained linkage support system according to claim 14, further comprising a force transmitting member wherein the acting end of the second linkage connector is connected to the force transmitting member.

16. The spring-retained linkage support system according to claim 15 wherein the force transmitting member is a slideable plate having a linkage end and a compacting end with a compacting die, the linkage end of the slideable compacting plate acting end of the second linkage connector.

17. The spring-retained linkage support system according to claim 14, further comprising a collapsible force input member with a first end, a second end, and a force input member wheel having an arm, wherein the first end of the force input member is connected to the force multiplying linkage and the second end of the collapsible force input member is connected to the arm.
